(19) United States
(12) Patent Application Publication
(10) Pub. No.: US 2026/0171675 A1
(43) Pub. Date: Jun. 18, 2026

(54) MILLIMETER-WAVE ANTENNA ASSEMBLY AND DISPLAY DEVICE

(71) Applicant: SHENZHEN TCL DIGITAL TECHNOLOGY LTD., Shenzhen (CN)

(72) Inventors: Liuzhong YIN, Shenzhen (CN); Yinghu MA, Shenzhen (CN); Zhiyong WANG, Shenzhen (CN)

(73) Assignee: SHENZHEN TCL DIGITAL TECHNOLOGY LTD., Shenzhen (CN)

(21) Appl. No.: 19/124,849

(22) PCT Filed: Aug. 25, 2023
(86) PCT No.: PCT/CN2023/114837

§ 371 Date: Apr. 25, 2025

(30) Foreign Application Priority Data
Oct. 26, 2022 (CN) 202211327285.0

(51) Int. Cl. H01Q 13/08; H01Q 1/22; H01Q 1/38

(52) U.S. Cl. CPC H01Q 13/08; H01Q 1/22; H01Q 1/38

(57) ABSTRACT

A millimeter-wave antenna assembly and a display device. The millimeter-wave antenna assembly comprises a first dielectric substrate, a micro strip line, a second dielectric substrate and a metal probe. The microstrip line is disposed on the first dielectric substrate. The second dielectric substrate is disposed on one side of the first dielectric substrate. The second dielectric substrate has a first side face provided with a first electric wall, and a second side face provided with a second electric wall. The metal probe is connected to the microstrip line, and the metal probe is suspended in the second dielectric substrate and is spaced apart from the first electric wall and the second electric wall.

This application claims priority to Chinese Application No. 202211327285.0 filed Oct. 26, 2022, and entitle with “MILLIMETER-WAVE ANTENNA ASSEMBLY AND DISPLAY DEVICE”, the contents of which are incorporated herein by reference in their entirety.

### FIELD OF THE INVENTION

The present invention relates to the field of communication technology, in particular to a millimeter-wave antenna assembly and a display device.

### BACKGROUND

At present, millimeter-wave antennas have the advantages of high bandwidth, narrow beam and small size, and are widely used in display devices. Among them, microstrip antennas are the main manifestation of millimeter-wave antennas. Microstrip antennas have the advantages of simple manufacturing process and high precision.

The structure of a microstrip antenna is composed of a dielectric substrate and a microstrip patch and a ground layer located on both sides of the dielectric substrate, the aperture plane of the microstrip antenna is parallel to the dielectric substrate, and the direction of the beams generated by the microstrip antenna is perpendicular to the plane where the dielectric substrate is located, that is, the microstrip antenna is a broadside-fire antenna, and the bandwidth of the broadside-fire antenna is narrow. If the microstrip antenna is set up with a large aperture plane, the area of the dielectric substrate required will be increased accordingly.

### TECHNICAL PROBLEM

When the area of the dielectric substrate is fixed, the size of the aperture plane generated by the microstrip antenna is limited.

### TECHNICAL SOLUTION

In a first aspect, an embodiment of the present disclosure provides a millimeter-wave antenna assembly, comprising:
a first dielectric substrate;
a microstrip line arranged on the first dielectric substrate;
a second dielectric substrate arranged on one side of the first dielectric substrate that is far away from the microstrip line, wherein the second dielectric substrate has a first plate face, a second plate face, a first side face, and a second side face, the first plate face is close to the first dielectric substrate, the second plate face is far away from the first dielectric substrate, the first side face and the second side face are connected with the first plate face and the second plate face, the second plate surface is arranged with a second electric wall, the first side face is connected with the second side face, the first side face is arranged with a first electric wall, and the second side face is provided for forming an aperture plane of the millimeter-wave antenna assembly; and
a metal probe connected with the microstrip line, wherein the metal probe penetrates through the first dielectric substrate and is suspended in the second dielectric substrate, and the metal probe is spaced apart from the first electric wall and the second electric wall.

In a second aspect, an embodiment of the present disclosure provides a display device comprising a circuit board and a millimeter-wave antenna assembly molded on the circuit board.

The millimeter-wave antenna assembly includes: a first dielectric substrate; a microstrip line arranged on the first dielectric substrate; a second dielectric substrate arranged on one side of the first dielectric substrate that is far away from the microstrip line, wherein the second dielectric substrate has a first plate face, a second plate face, a first side face, and a second side face, the first plate face is close to the first dielectric substrate, the second plate face is far away from the first dielectric substrate, the first side face and the second side face are connected with the first plate face and the second plate face, the second plate surface is arranged with a second electric wall, the first side face is connected with the second side face, the first side face is arranged with a first electric wall, and the second side face is provided for forming an aperture plane of the millimeter-wave antenna assembly; and a metal probe connected with the microstrip line, wherein the metal probe penetrates through the first dielectric substrate and is suspended in the second dielectric substrate, and the metal probe is spaced apart from the first electric wall and the second electric wall.

The circuit board and the millimeter-wave antenna assembly share the first dielectric substrate.

### ADVANTAGEOUS EFFECT

The present disclosure provides a millimeter-wave antenna assembly and a display device. The millimeter-wave antenna comprises a first dielectric substrate and a second dielectric substrate, and the second dielectric substrate is arranged on one side of the first dielectric substrate that is far away from the microstrip line. The second dielectric substrate has a first plate face, a second plate face, a first side face, and a second side face. The first plate face is close to the first dielectric substrate, and the second plate face is far away from the first dielectric substrate. The first side face is arranged with a first electric wall, and the second plate face is arranged with a second electric wall. One terminal of a metal probe is connected with a microstrip line, the other terminal penetrates through the first dielectric substrate and is suspended in the second dielectric substrate. The metal probe is spaced from the first electric wall and the second electric wall. It is understandable that, due to the blocking effect of the first electric wall and the second electric wall, the second side face is arranged to form the aperture plane of the millimeter-wave antenna assembly, and the millimeter-wave antenna assembly can transmit or receive radio frequency signals through the aperture plane. Therefore, the size of the aperture plane of the millimeter-wave antenna assembly is determined by the second side face of the second dielectric substrate, and the second side face does not overlap the plane where the first dielectric substrate is located, that is, the millimeter-wave antenna assembly is an end-fire antenna and is not limited by the area size of the first dielectric substrate.

### BRIEF DESCRIPTION OF THE DRAWINGS

FIG. 1 is a schematic diagram of a first structure of a millimeter-wave antenna assembly according to an embodiment of the present disclosure.

FIG. 2 is a schematic diagram of a structure of a second dielectric substrate according to an embodiment of the present disclosure.

FIG. 3 is a beam directional diagram of a microstrip antenna of the related technology.

FIG. 4 is a beam directional diagram of a millimeter-wave antenna assembly according to an embodiment of the present disclosure.

FIG. 5 is a voltage standing wave ratio (VSWR) diagram of a microstrip antenna of the related technology.

FIG. 6 is a VSWR diagram of a millimeter-wave antenna assembly according to an embodiment of the present disclosure.

FIG. 7 is a schematic diagram of a structure of a first dielectric substrate according to an embodiment of the present disclosure.

FIG. 8 is a schematic diagram of a structure of a third dielectric substrate according to an embodiment of the present disclosure.

FIG. 9 is a schematic diagram of a second structure of a millimeter-wave antenna assembly according to an embodiment of the present disclosure.

### DETAILED DESCRIPTION OF THE PRESENT DISCLOSURE

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be acquired according to these drawings without creative labor.

In the related art, millimeter-wave antennas have the advantages of high bandwidth, narrow beam and small size, and are widely used in display devices. Among them, microstrip antennas are the main manifestation of millimeter-wave antennas. Microstrip antennas have the advantages of simple manufacturing process and high precision.

The structure of a microstrip antenna is composed of a dielectric substrate and a microstrip patch and a ground layer located on both sides of the dielectric substrate, the aperture plane of the microstrip antenna is parallel to the dielectric substrate, and the direction of the beams generated by the microstrip antenna is perpendicular to the plane where the dielectric substrate is located, that is, the microstrip antenna is a broadside-fire antenna, and the bandwidth of the broadside-fire antenna is narrow. If the microstrip antenna is set up with a large aperture plane, the area of the dielectric substrate required will be increased accordingly

In order to solve the above problem of microstrip antennas, embodiments of the present disclosure provide a millimeter-wave antenna assembly and a display device. The aperture plane of the millimeter-wave antenna assembly does not overlap the plane where a first dielectric substrate is located and is not limited by the area size of the first dielectric substrate.

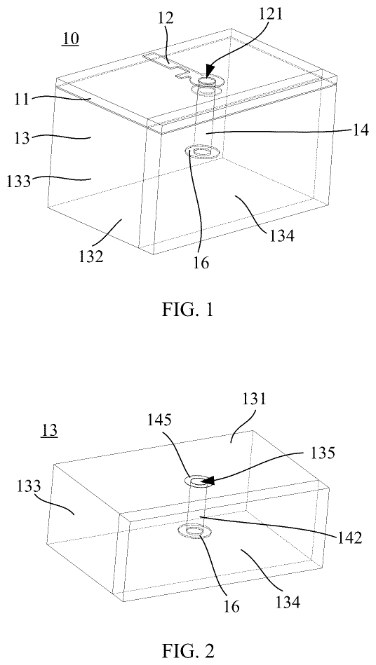

Referring to FIG. 1 and FIG. 2, FIG. 1 is a schematic diagram of a first structure of a millimeter-wave antenna assembly according to an embodiment of the present disclosure, and FIG. 2 is a schematic diagram of a structure of a second dielectric substrate according to an embodiment of the present disclosure. The following is illustrated in conjunction with the accompanying drawings.

The present disclosure provides a millimeter-wave antenna assembly 10, and the millimeter-wave antenna assembly 10 comprises a first dielectric substrate 11, a microstrip line 12, a second dielectric substrate 13 and a metal probe 14.

The microstrip line 12, the first dielectric substrate 11, and the second dielectric substrate 13 are stacked in succession. The microstrip line 12 is arranged on the first dielectric substrate 11, and the second dielectric substrate 13 is arranged on one side of the first dielectric substrate 11 that is far away from the microstrip line 12. The second dielectric substrate 13 has a first plate face 131, a second plate face 132, a first side face 133, and a side face 134. The first side face 133 is connected with the second side face 134. The first plate face 131 of the second dielectric substrate 13 is close to the first dielectric substrate 11, and the second plate face 132 of the second dielectric substrate 13 is far away from the first dielectric substrate 11. The first side face 133 and the second side face 134 are all connected with the first plate face 131 and the second plate face 132. The first side face 133 is arranged with a first electric wall, and the second plate face 132 is arranged with a second electric wall.

The metal probe 14 is connected with the microstrip line 12, the metal probe 14 penetrates through the first dielectric substrate 11 and is suspended in the second dielectric substrate 13. The metal probe 14 is spaced apart from the first electric wall and the second electric wall. It can be seen that when the microstrip line 12 is fed with electricity, the second side face 134 can form an aperture plane of the millimeter-wave antenna assembly 10, and the millimeter-wave antenna assembly 10 can transmit or receive radio frequency signals through the aperture plane.

It is noted that the first side face 133 and the second side face 134 are used to distinguish whether the side face of the second dielectric substrate 13 is arranged with the first electric wall. The first side face 133 is arranged with the first electric wall, and the second side face 134 is not arranged with the first electric wall. For example, the second dielectric substrate 13 may be a rectangular parallelepiped. The rectangular parallelepiped is arranged on the first dielectric substrate 11. The face of the second dielectric substrate 13 close to the first dielectric substrate 11 is the first plate face 131, and the face thereof away from the first substrate is the second plate face 132. The second dielectric substrate 13 comprises four side faces connected with the first plate face 131 and the second plate face 132, which are the first sub-side face, the second sub-side face, the third sub-side face, and the fourth sub-side face connected in turn. The first sub-side face, the second sub-side face, and the third sub-side face are regarded as the first side face 133, and the fourth sub-side face is regarded as the second side face 134. In the above description, the second dielectric substrate 13 that is a rectangular parallelepiped is taken as an example for illustrative purposes only, and in practice, the second dielectric substrate 13 can be arranged with different shapes as needed to meet the setting of the millimeter-wave antenna assembly 10 in the present disclosure.

It is understandable that, due to the blocking effect of the first electric wall and the second electric wall, the second side face 134 is configured to form the aperture plane of the millimeter-wave antenna assembly 10, and the millimeter-wave antenna assembly 10 can transmit or receive radio frequency signals through the aperture plane. Therefore, the size of the aperture plane of the millimeter-wave antenna assembly 10 is determined by the second side face 134 of the second dielectric substrate 13, and the second side 134 does not overlap the plane where the first dielectric substrate 11 is located, that is, the millimeter-wave antenna assembly 10 is an end-fire antenna and is not limited by the area size of the first dielectric substrate 11.

In some embodiments, the first electric wall is arranged with metallized holes or conductive layers arranged in rows. Alternatively, the second electrical wall is arranged with metallized holes or conductive layers arranged in rows. The conductive layers can be fabricated by metal layers or metal sheets. The main effect of the first electric wall and the second electric wall is to block electromagnetic waves in the first dielectric substrate 11.

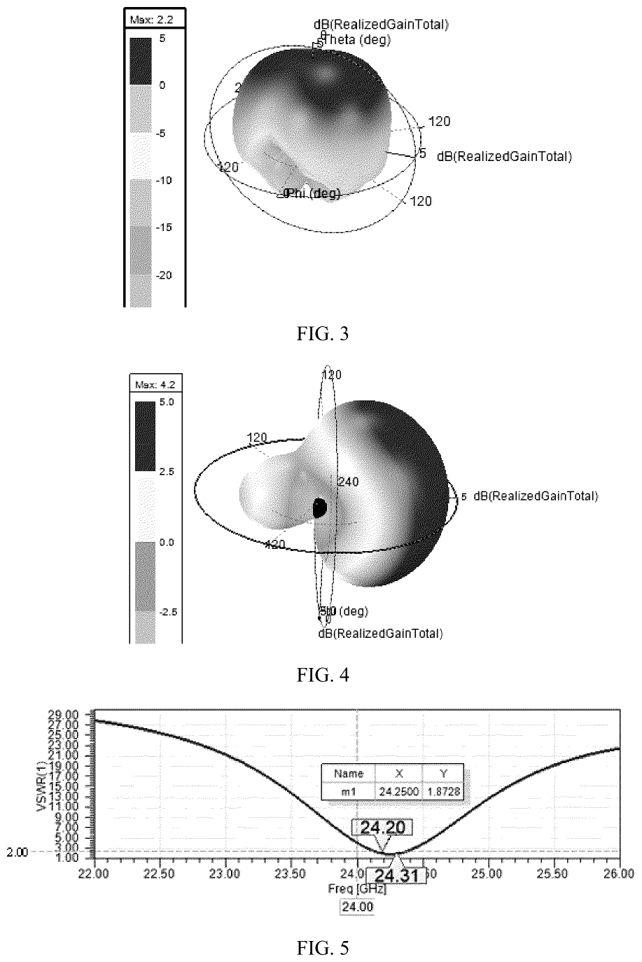

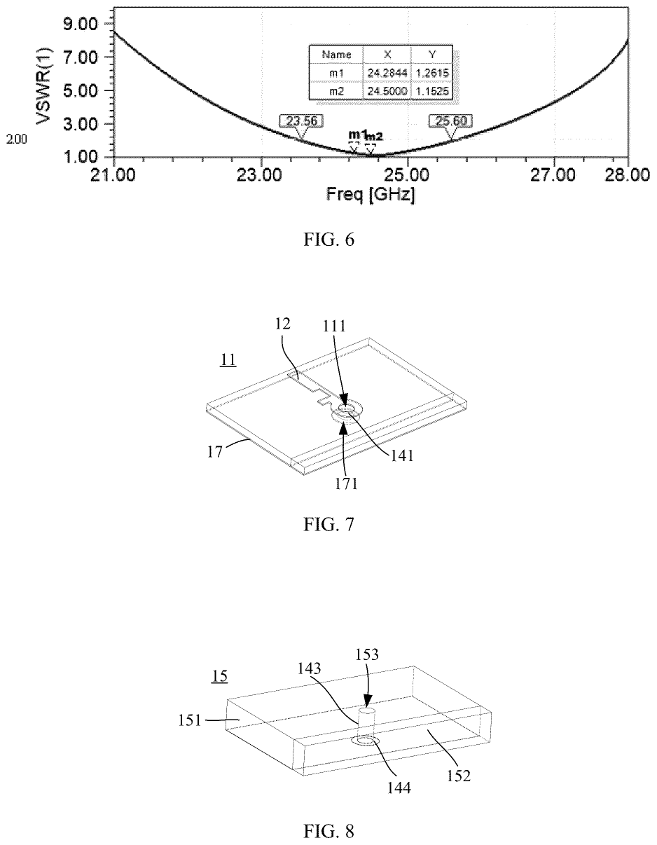

In some embodiments, the first dielectric substrate 11 is parallel to the second dielectric substrate 13, and the first side face 133 and the second side face 134 are perpendicular to the first dielectric substrate 11 and the second dielectric substrate 13. That is, by arranging the second dielectric substrate 13 in the thickness direction of the first dielectric substrate 11, the first plate face 131 and the second plate face 132 are perpendicular to the thickness direction of the first dielectric substrate 11, and the first side face 133 and the second side face 134 are parallel to the thickness direction of the first dielectric substrate 11. The direction of beams generated by the millimeter-wave antenna assembly 10 in the embodiment of the present disclosure is parallel to the first dielectric substrate 11, and the millimeter-wave antenna assembly 10 is an end-fire antenna. FIG. 3 and FIG. 4 are shown for the case where the microstrip antenna is formed on the third dielectric substrate 15 and the third dielectric substrate 15 is parallel to the first dielectric substrate 11. FIG. 3 is a beam directional diagram of a microstrip antenna of the related technology. FIG. 4 is a beam directional diagram of the millimeter-wave antenna assembly provided in the embodiment of the present disclosure. The beam direction of the millimeter-wave antenna assembly is deflected by 90 degrees relative to the beam direction of the microstrip antenna. Refer to FIG. 5 and FIG. 6. FIG. 5 is a VSWR diagram of a microstrip antenna of the related technology, and FIG. 6 is a VSWR diagram of the millimeter-wave antenna assembly provided in the embodiment of the present disclosure. When the VSWR of the microstrip antenna is less than or equal to 2, the bandwidth of the microstrip antenna is ranged from 24.2 GHz to 24.31 GHz, that is, the absolute bandwidth is 0.11 GHz, and the relative bandwidth is 0.45%; when the VSWR of the millimeter-wave antenna assembly 10 is less than or equal to 2, the bandwidth of the millimeter-wave antenna assembly 10 is ranged from 23.56 GHz to 25.6 GHz, that is, the absolute bandwidth is 2.04 GHz, and the relative bandwidth is 8.3%. It can be seen that the bandwidth of the millimeter-wave antenna assembly 10 provided in the embodiment of the present disclosure is much larger than the bandwidth of the microstrip antenna in the related technology, and the bandwidth expansion of the millimeter-wave antenna assembly 10 provided in the embodiment of the present disclosure is significant.

It is understandable that, because the first electric wall and the second electric wall form a metal cavity, the second side face 134 is configured to form the aperture plane of the millimeter-wave antenna assembly 10 due to the blocking effect of the metal cavity, and the millimeter-wave antenna assembly 10 can transmit or receive radio frequency signals through the aperture plate. Therefore, the size of the aperture plane of the millimeter-wave antenna assembly 10 is determined by the second side face 134 of the second dielectric substrate 13, and the second lateral surface 134 does not overlap the plane where the first dielectric substrate 11 is located, that is, the millimeter-wave antenna assembly 10 is an end-fire antenna and is not limited by the area size of the first dielectric substrate 11, and the bandwidth expansion of the millimeter-wave antenna assembly 10 is significant.

In some embodiments, the millimeter-wave antenna assembly 10 is molded on a circuit board. The circuit board shares the first dielectric substrate 11 with the millimeter-wave antenna assembly 10. The circuit board can be a printed circuit board (PCB) or a flexible printed circuit board (FPC). Therefore, when the millimeter-wave antenna assembly 10 is fabricated, the mature process related to the fabrication of PCB or FPC can be adopted, so that the production cost and difficulty can be effectively reduced. It is understandable that, through forming the second dielectric substrate 13 on the first dielectric substrate 11 of the circuit board, the first electric wall and the second electric wall are arranged on the first side face 133 and the second plate face 132 of the second dielectric substrate 13 respectively, then the metal probe 14 penetrates through the first dielectric substrate 11 and suspended in the second dielectric substrate 13, then the microstrip line 12 is arranged on one side of the first dielectric substrate 11 that is far away from the second dielectric substrate 13, and finally the metal probe 14 is connected with the microstrip line 12, so that the millimeter-wave antenna assembly 10 can be molded on a circuit board.

The metal probe 14 has a first terminal and a second terminal, the first terminal of the metal probe 14 is connected with the microstrip line 12, and the second terminal thereof is suspended in the second dielectric substrate 13. The second terminal can be a free terminal.

In some embodiments, please continue to refer to FIG. 1, FIG. 2, and FIG. 7. FIG. 7 is a schematic diagram of the structure of the first dielectric substrate provided in the embodiment of the present disclosure. The metal probe 14 comprises a first conductor segment 141 and a second conductor segment 142 electrically connected to the first conductor segment 141. The second conductor segment 142 has a free terminal. The first dielectric substrate 11 is arranged with a first through hole 111. The first conductor segment 141 penetrates through the first through hole 111. Optionally, the first through hole 111 can be a metallized via, that is, the first conductor segment 141 is arranged on the wall of the first through hole 111. The first microstrip wire 12 is electrically connected with the first conductor segment 141, and the free terminal of the second conductor segment 142 is suspended in the second dielectric substrate 13.

In some embodiments, referring to FIG. 7, a blind hole 135 is arranged in the second dielectric substrate 13, and the blind hole 135 is communicated with the first through hole 111. The second conductor segment 142 is permeated into the blind hole 135. Optionally, the second conductor segment 142 is arranged on the wall of the blind hole 135.

In some embodiments, the second dielectric substrate 13 is arranged with a second through hole, the second through hole is communicated with the first through hole 111, and the second conductor segment 142 penetrates through the second through hole. Optionally, the second through hole may be a metallized via, that is, the second conductor segment 142 is arranged on the wall of the second through hole. The second electric wall is spaced from the free terminal of the second conductor. When the second electric wall is a metal layer or a metal sheet, an avoidance space is arranged on the second electric wall, such as an avoidance hole, and the avoidance space is arranged correspondingly to the second conductor, so that the second electric wall is isolated from the second conductor.

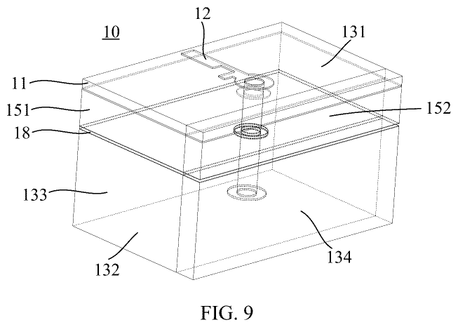

In some embodiments, refer to FIG. 8 and FIG. 9. FIG. 8 is a schematic diagram of the structure of the third dielectric substrate provided in the embodiment of the present disclosure. FIG. 9 is a schematic diagram of a second structure of the millimeter-wave antenna assembly provided in the embodiment of the present disclosure. The millimeter-wave antenna assembly 10 further comprises a third dielectric substrate 15. The third dielectric substrate 15 is arranged between the first dielectric substrate 11 and the second dielectric substrate 13. The third dielectric substrate 15 has a third side face 151 and a fourth side face 152. The third side face 151 is arranged with a third electric wall, and the third electric wall is arranged correspondingly to the first electric wall. The metal probe 14 further comprises a third conductor segment 143. The third conductor segment 143 is electrically connected with the first conductor segment 141 and the second conductor segment 142 respectively. The third conductor segment 143 penetrates through the third dielectric substrate 15. Optionally, the third dielectric substrate 15 is arranged with a third through hole 153. The third conductor segment 143 penetrates through the third through hole 153. The third through hole 153 can be a metallized via, that is, the third conductor segment 143 is arranged on the wall of the third through hole 153.

It is understandable that, by arranging the third dielectric substrate 15, the second side face 134 of the second dielectric substrate 13 and the third side face 151 of the third dielectric substrate 15 jointly form the aperture plane of the millimeter-wave antenna, that is, the aperture plane of the millimeter-wave antenna assembly 10 can be effectively expanded, and the area of the aperture plane of the millimeter-wave antenna assembly 10 can be increased.

Referring to FIG. 7 and FIG. 8, the metal probe 14 further comprises a first flange 144 and a second flange 145. The first flange 144 is electrically connected with the second flange 145. The first flange 144 is arranged on one side of the third dielectric substrate 15 that is far away from the first dielectric substrate 11, and the first flange 144 is electrically connected with the third conductor segment 143. The second flange 145 is arranged on one side of the second dielectric substrate 13 that is close to the first dielectric substrate 11, and the second flange 145 is electrically connected with the second conductor segment 142. The first flange 144 and the second flange 145 are electrically connected through a solder placement process. An oil film 18 is further arranged between the first dielectric substrate 11 and the second dielectric substrate 13. The oil film 18 covers the first flange 144 and the second flange 145. The oil film 18 is used for preventing oxidation of the first flange 144 and the second flange 145.

Referring to FIG. 1 and FIG. 2, the millimeter-wave antenna assembly 10 further comprises a tuning portion 16. The tuning portion 16 is electrically connected to one end of the second conductor segment 142 that is away from the first conductor segment 141. The tuning portion 16 can be a metal disk or a segment. The tuning part 16 has the effect of tuning the impedance of the millimeter-wave antenna assembly 10.

The millimeter-wave antenna assembly 10 further comprises a ground layer 17. The ground layer 17 is arranged on one side of the first dielectric substrate 11 that is far away from the microstrip line 12. The metal probe 14 is spaced apart from the ground layer 17. The ground layer 17, the first electric wall, and the second electric wall form a semi-closed dielectric cavity, so that the opening of the dielectric cavity forms the aperture plane of the millimeter-wave antenna assembly 10.

Referring to FIG. 7, the ground layer 17 is arranged with a first opening 171. The first opening 171 is arranged correspondingly to the metal probe 14. The first opening 171 can accommodate the metal probe 14 to penetrate out. The first opening 171 is used for impedance matching.

In some embodiments, referring to FIG. 1, the microstrip line 12 is arranged with a second opening 121. The second opening 121 is also arranged correspondingly to the metal probe 14. The second opening 121 is used for impedance matching.

The present disclosure also provides a display device. The display device comprises a circuit board. The millimeter-wave antenna assembly 10 is molded on the circuit board, and the circuit board shares a first dielectric substrate 11 with the millimeter-wave antenna assembly 10.

If the microstrip line 12 antenna is installed in the display device, in order to make the millimeter-wave antenna to efficiently radiate and receive signals, the aperture plane of the microstrip antenna needs to be perpendicular to the normal of the display screen of the display device. Therefore, when the user uses the display device, the direction of the beams generated by the microstrip antenna can be direct to the human body, and the microstrip antenna can efficiently transmit or receive radio frequency signals. However, a microstrip antenna is generally located in the non-display area of the display device, such as the frame. If the aperture plane of the microstrip antenna needs to be perpendicular to the normal of the display screen of the display device, the positive projection of the microstrip antenna in the non-display area has a certain area, which will lead to the increase in the proportion of the non-display area relative to the entire display screen and the decrease in the screen ratio.

The dielectric substrate in the microstrip antenna can also be a dielectric substrate in a circuit board, that is, the microstrip antenna can be molded on the circuit board. If the microstrip antenna is set in the non-display area of the display device, the circuit board is also arranged in the non-display area accordingly. Therefore, the non-display area should not only provide accommodation space for the microstrip antenna, but also provide accommodation space for the circuit board formed with microstrip line 12, which increases the proportion of the non-display area relative to the entire display screen and further decreases the screen ratio.

According to the embodiment of the present disclosure, in the case where the circuit board formed with the millimeter-wave antenna assembly 10 is arranged in the display device, when the direction of the beams generated by the millimeter-wave antenna assembly 10 is required to be perpendicular to the display screen, the first dielectric substrate 11 and the circuit board are arranged in parallel with the normal of the display screen, which greatly decreases the area of the non-display area of the display device and is beneficial to increase the screen ratio of the display device. The embodiment of the present disclosure provides a millimeter-wave antenna assembly 10 and a display device. The millimeter-wave antenna assembly 10 comprises a first dielectric substrate 11 and a second dielectric substrate 13, and the second dielectric substrate 13 is arranged on one side of the first dielectric substrate 11 that is away from a microstrip line 12. The second dielectric substrate 13 has a first plate face 131, a second plate face 132, a first side face 133, and a second face 134. The first plate face 131 is close to the first dielectric substrate 11, and the second plate face 132 is far away from the first dielectric substrate 11. The first plate face 133 is arranged with a first electric wall, and the second plate face 132 is arranged with a second electric wall. One terminal of a metal probe 14 is connected with the microstrip line 12, the other terminal penetrates through the first dielectric substrate 11 and is suspended in the second dielectric substrate 13. The metal probe 14 is spaced apart from the first electric wall and the second electric wall. It is understandable that, due to the blocking effect of the first electric wall and the second electric wall, the second side face 134 is arranged to form the aperture plane of the millimeter-wave antenna assembly 10, and the millimeter-wave antenna assembly 10 can transmit or receive radio frequency signals through the aperture plane. Therefore, the size of the aperture plane of the millimeter-wave antenna assembly 10 is determined by the second side face 134 of the second dielectric substrate 13, and the second side face 134 does not overlap the plane where the first dielectric substrate 11 is located, that is, the millimeter-wave antenna assembly 10 is an end-fire antenna and is not limited by the area size of the first dielectric substrate 11.

In the above embodiments, the descriptions of each embodiment have their own emphasis, and the part that is not detailed in a certain embodiment may be referred to the relevant descriptions of other embodiments.

In the description of the present disclosure, the terms “first” and “second” are used for descriptive purposes only and should not be construed as indicating or implying relative importance or implying the number of technical features indicated. Thus, defining the “first” and “second” features may explicitly or implicitly include one or more features.

The millimeter wave antenna assembly and display device provided in the embodiment of the present disclosure are described in detail above. In the present disclosure, specific examples are used to explain the principles and embodiments of the present disclosure, and the descriptions of the above embodiments are only used to help understand the present disclosure. At the same time, for those skilled in the art, there will be changes in the specific embodiment and scope of application according to the idea of the present disclosure, and in summary, the contents of this specification should not be construed as a restriction on the present disclosure.

1. A millimeter-wave antenna assembly, comprising:
a first dielectric substrate;
a microstrip line arranged on the first dielectric substrate;
a second dielectric substrate arranged on one side of the first dielectric substrate that is far away from the microstrip line, wherein the second dielectric substrate has a first plate face, a second plate face, a first side face, and a second side face, the first plate face is close to the first dielectric substrate, the second plate face is far away from the first dielectric substrate, the first side face and the second side face are connected with the first plate face and the second plate face, the second plate surface is arranged with a second electric wall, the first side face is connected with the second side face, the first side face is arranged with a first electric wall, and the second side face is provided for forming an aperture plane of the millimeter-wave antenna assembly; and
a metal probe connected to the microstrip line, wherein the metal probe penetrates through the first dielectric substrate and is suspended in the second dielectric substrate, and the metal probe is spaced apart from the first electric wall and the second electric wall.

2. The millimeter-wave antenna assembly of claim 1, wherein metal probe comprises a first conductor segment and a second conductor segment electrically connected with the first conductor segment, the first dielectric substrate is arranged with a first through hole, the first conductor segment is arranged on a wall of the first through hole, the microstrip line is electrically connected with the first conductor segment, and a free terminal of the second conductor segment is suspended in the second dielectric substrate.

3. The millimeter-wave antenna assembly of claim 2, wherein the second dielectric substrate is arranged with a blind hole, the blind hole is communicated with the first through hole, and the second conductor segment is arranged in the blind hole.

4. The millimeter-wave antenna assembly of claim 3, wherein the second conductor segment is arranged on a wall of the blind hole.

5. The millimeter-wave antenna assembly of claim 2, wherein the second dielectric substrate is arranged with a second through hole, the second through hole is communicated with the first through hole, the second conductor segment is arranged on a wall of the second through hole, and the second electric wall is spaced from the free terminal of the second conductor segment.

6. The millimeter-wave antenna assembly of claim 2, further comprising a third dielectric substrate, wherein the third dielectric substrate is arranged between the first dielectric substrate and the second dielectric substrate, the third dielectric substrate has a third side face and a fourth side face, the third side face is arranged with a third electric wall, the third electric wall is arranged correspondingly to the first electric wall, the metal probe further comprises a third conductor segment, the third conductor segment is electrically connected with the first conductor segment and the second conductor segment respectively, and the third conductor segment penetrates through the third dielectric substrate.

7. The millimeter-wave antenna assembly of claim 6, wherein the metal probe further comprises a first flange and a second flange, the first flange is electrically connected with the second flange, the first flange is arranged on one side of the third dielectric substrate that is far away from the first dielectric substrate, the first flange is electrically connected with the third conductor segment, the second flange is arranged on one side of the second dielectric substrate that is close to the first dielectric substrate, and the second flange is electrically connected with the second conductor segment.

8. The millimeter-wave antenna assembly of claim 7, further comprising an oil film, wherein the oil film is arranged between the first flange and the second flange.

9. The millimeter-wave antenna assembly of claim 2, further comprising a tuning portion, wherein the tuning portion is electrically connected with one terminal of the second conductor segment that is far away from the first conductor segment.

10. The millimeter-wave antenna assembly of claim 9, wherein the tuning portion is a metal disk.

11. The millimeter-wave antenna assembly of claim 1, further comprising a ground layer, wherein the ground layer is arranged on one side of the first dielectric substrate that is far away from the microstrip line, and the metal probe is spaced apart from the ground layer.

12. The millimeter-wave antenna assembly of claim 11, wherein the ground plane is arranged with a first opening, the first opening is arranged correspondingly to the metal probe, and the first opening accommodates the metal probe to penetrate out.

13. The millimeter-wave antenna assembly of claim 1, wherein the microstrip line is arranged with a second opening, and the second opening is arranged correspondingly to the metal probe pair.

14. The millimeter-wave antenna assembly of claim 1, wherein the first electric wall is arranged with metallized holes or conductive layers arranged in rows.

15. The millimeter-wave antenna assembly of claim 1, wherein the second electric wall is arranged with metallized holes or conductive layers arranged in rows.

16. A display device comprising:
a circuit board; and
a millimeter-wave antenna assembly formed on the circuit board, wherein the millimeter-wave antenna assembly comprises:
a first dielectric substrate;
a microstrip line arranged on the first dielectric substrate;
a second dielectric substrate arranged on one side of the first dielectric substrate that is far away from the microstrip line, wherein the second dielectric substrate has a first plate face, a second plate face, a first side face, and a second side face, the first plate face is close to the first dielectric substrate, the second plate face is far away from the first dielectric substrate, the first side face and the second side face are connected with the first plate face and the second plate face, the second plate surface is arranged with a second electric wall, the first side face is connected with the second side face, the first side face is arranged with a first electric wall, and the second side face is provided for forming an aperture plane of the millimeter-wave antenna assembly; and
a metal probe connected to the microstrip line, wherein the metal probe penetrates through the first dielectric substrate and is suspended in the second dielectric substrate, and the metal probe is spaced apart from the first electric wall and the second electric wall;
wherein the circuit board and the millimeter-wave antenna assembly share the first dielectric substrate.

17. The display device of claim 16, wherein the first dielectric substrate and the circuit board are arranged in parallel with a normal of a display screen.

18. The display device of claim 16, wherein metal probe comprises a first conductor segment and a second conductor segment electrically connected with the first conductor segment, the first dielectric substrate is arranged with a first through hole, the first conductor segment is arranged on a wall of the first through hole, the microstrip line is electrically connected with the first conductor segment, and a free terminal of the second conductor segment is suspended in the second dielectric substrate.

19. The display device of claim 16, further comprising a grounding layer arranged on one side of the first dielectric substrate far away from the microstrip line, wherein the metal probe is spaced apart from the grounding layer.

20. The display device of claim 16, wherein the first electric wall is arranged with metallized holes or conductive layers arranged in rows.
